(19) United States
(12) Patent Application Publication
(10) Pub. No.: US 2004/0220700 A1
(43) Pub. Date: Nov. 4, 2004

(54) Comfort thermostat

(76) Inventors: David Harvey Schroeder, Glen Ellyn, IL (US); Russell Edward Schroeder, Horicon, WI (US)

Correspondence Address: David H. Schroeder, 362 Hawthorne Blvd., Glen Ellyn, IL, 60137, US

(21) Appl. No.: 10/788,956

(22) Filed: Feb. 27, 2004

Related U.S. Application Data
(60) Provisional application No. 60/450,236, filed on Feb. 27, 2003.

(51) Int. Cl. G01M 1/38; G05B 15/00; G05D 23/00; G05B 13/00; G05B 21/00

(52) U.S. Cl. 700/276; 700/277

(57) ABSTRACT

Abstract: The present invention discloses a method for controlling heating/cooling equipment to maintain a more consistently comfortable controlled environment. The process responds to minute fractional degree temperature changes in combination with logic to maintain high temperature consistency while protecting equipment from excessive rapid cycling. An encoding and decoding algorithm of the process saves thermostat cable conductors while assuring high reliability operation. A particular feature of the present invention is a one touch means of temporarily modifying the effective temperature setting on demand without complex programming actions, and returning to the original temperature setting automatically after a period of time.

### BACKGROUND

This application is entitled to the benefit of Provisional Patent Application Ser.# 60/450,236 filed Feb. 27, 2003.

1. Field of Invention

The invention relates to control of heating, ventilation, and cooling (HVAC) equipment to maintain a comfortable controlled environment.

2. Description of Prior Art

The device used to control operation of HVAC equipment is typically referred to as a thermostat. In older mechanical thermostats, a bimetal strip or coil operated electrical contacts, often with an anticipator adjustment to control equipment run time. In more recent electronic thermostats, a digital temperature sensor having discrete resolution is used. Some thermostats operate on fixed temperature differential of one or two degrees, while others have a selectable differential of for example 0.5, 1.0, or 1.5 degrees.

There are many inherent disadvantages with the process of prior art. For example, once the set point temperature is reached turning equipment on, it may take a considerable amount of time before the temperature at the thermostat changes sufficiently to cause equipment to be turned off.

Even if a small operational differential of one degree or less is in effect at the thermostat, in practice the actual room temperature differential from the time HVAC equipment starts until it shuts off may be several degrees. Many economy minded individuals set winter heating temperatures as low as they can comfortably tolerate, and when room temperature falls below that they feel the discomfort. Even a few degrees differential range makes a big comfort impact, especially with elderly persons. A problem with prior art is that the logic is fixed, and not adaptive to the many varying environmental conditions of ordinary use. For example, when a heating system is in use, there is always a temperature gradient between the source of the heat (or the center of the heated area) and the perimeter of the heated area. The magnitude of the gradient is dependent on many variables including type of.construction, quality of insulation, wind speed, difference between indoor and outdoor ambient temperature, and etc. In the case of commonly used forced air systems, once the furnace and fan turns off, this gradient begins increasing. In typical situations where the furnace may not restart for as much as an hour or more, discomfort due to a substantial temperature gradient can be substantial. While operating the fan continuously can ameliorate this gradient, many people object to the continuous drone noise of fan operation, the increased electrical operating cost, and to the uncomfortable feeling of blowing unheated air.

A disadvantage of current digital electronic thermostats is that the temperature adjustment is permitted in whole degrees only. Field experience shows that increasing the temperature setting one whole degree may cause the furnace to run continuously for as much as twenty minutes or more depending on thermostat location and other factors. During this time, some parts of the heated area may become uncomfortably warm. Conversely, lowering the setting one whole degree may result in the furnace remaining off for an extended period during which time portions of the living area may become quite uncomfortable.

Even when a thermostat is maintaining a steady temperature many people complain that although they feel comfortable when active during the day, they feel chilly when they sit down to relax in the evening and have a difficult time fiddling with the thermostat setting to get it right.

There is a need for a mechanism to improve comfort of HVAC systems by increasing the consistency of controlled temperature at a modest cost, and a need to provide simplified means of minor temperature modification on demand without affecting the usual temperature setting or requiring programming actions.

### SUMMARY OF THE-INVENTION

The present invention includes method claims for an improved comfort thermostat control. The method or process of the present invention includes logic used with a sensitive temperature sensor to achieve near zero temperature differential operation. The set point can be adjusted on a continuous or fractional degree basis rather than to whole degree values.

The process further includes logic to control minimum equipment operation time to protect mechanical equipment from excess cycling. The process provides a means of changing such minimum operation time to match equipment requirements and user preference.

The process further includes independent logic to optionally control periodic air circulation to minimize temperature gradients with more comfort and better economy of operation.

The process further includes a means of determining if the operator desires a temporary modification to the current effective temperature setting, and if so determined, changing the effective temperature setting for a period of time and then returning to the original temperature setting automatically.

The process further includes a means of separating thermostat functions related to operator control and feedback from thermostat components that directly control HVAC equipment. Novel encoding and decoding logic permits digital control data to be passed from the thermostat location to the equipment location with high reliability using fewer wires.

### OBJECTS AND ADVANTAGES

Accordingly, several objects and advantages of my invention are increased precision of temperature control, an easy one touch means of temporarily increasing temperature for operator comfort with automatic return to the previous setting after a period of time, and the ability to reduce the number of thermostat cable conductors required. Since a 24 Volt AC supply is not required for the thermostat, when using one conductor for ground reference and one conductor for digital signal path, a third conductor could be used with the ground reference to provide power to operate thermostat electronics. Considering lower power handling requirement and fewer conductors, a considerable savings in copper can be achieved.

Other objects and advantages include thermostat size reduction. Size reduction is possible by locating some of the typical thermostat elements at the equipment location. A further advantage is the option to connect a thermostat using a coaxial cable, light conducting fiber, or radio frequency link.

Further objects and advantages of my invention will become apparent from a consideration of the drawings and ensuing description.

### DESCRIPTION OF THE DRAWINGS

FIG. 1 is a block diagram depicting one embodiment of the invention.

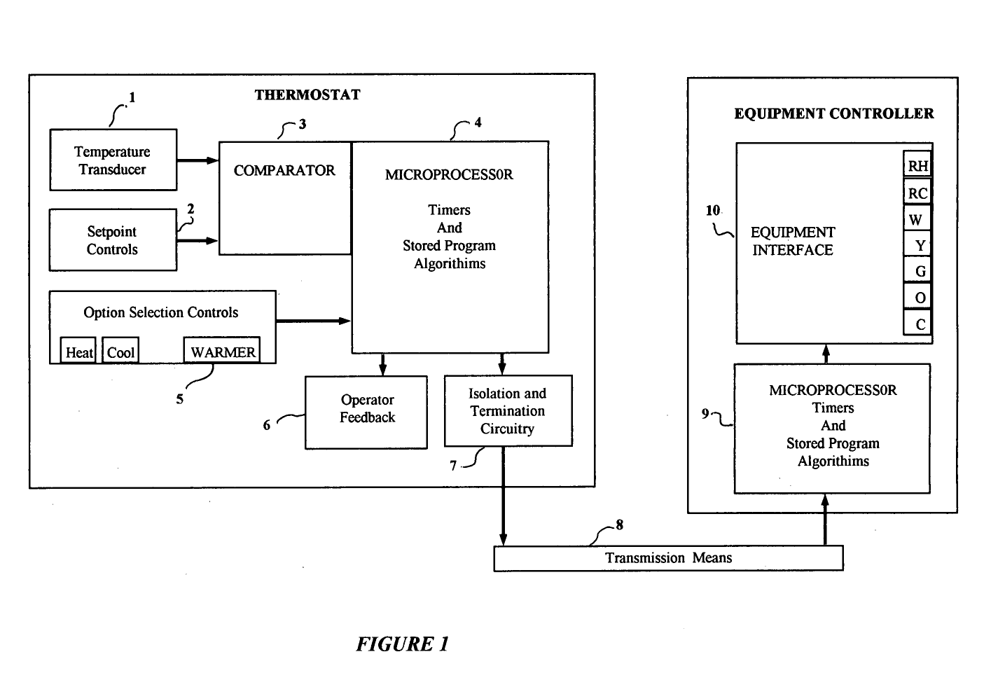

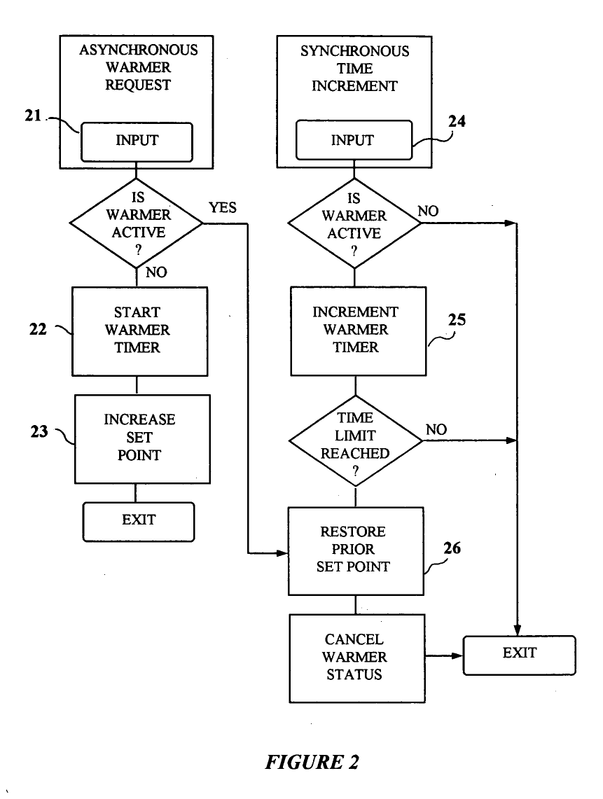

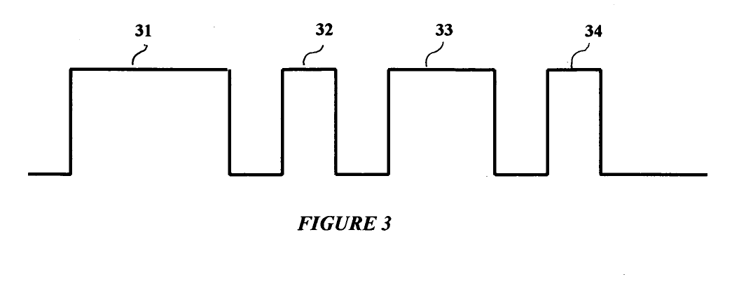

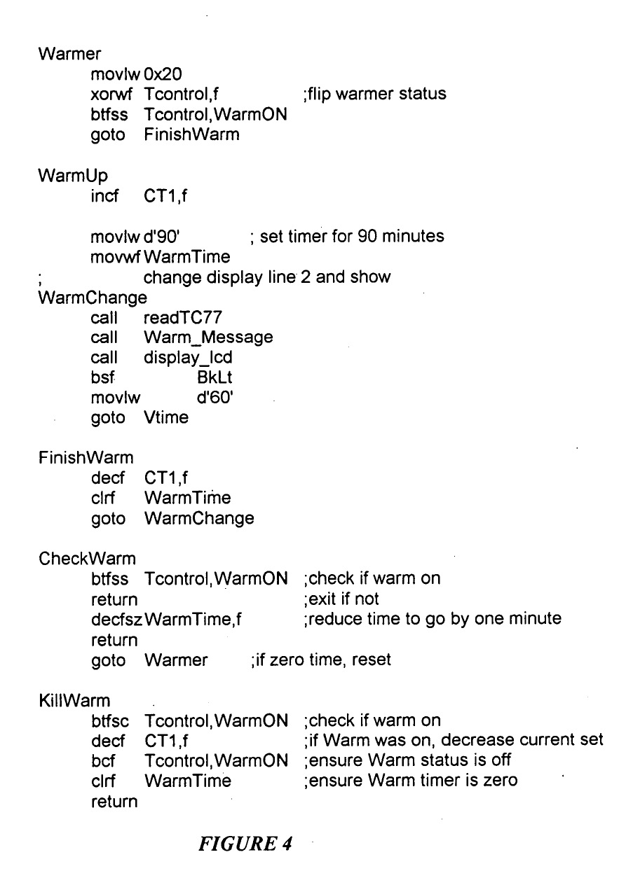

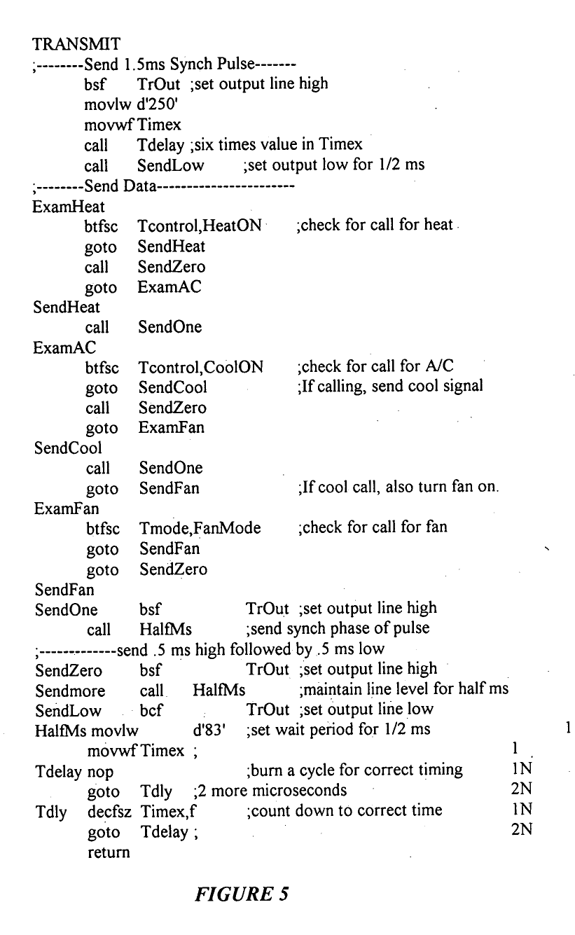

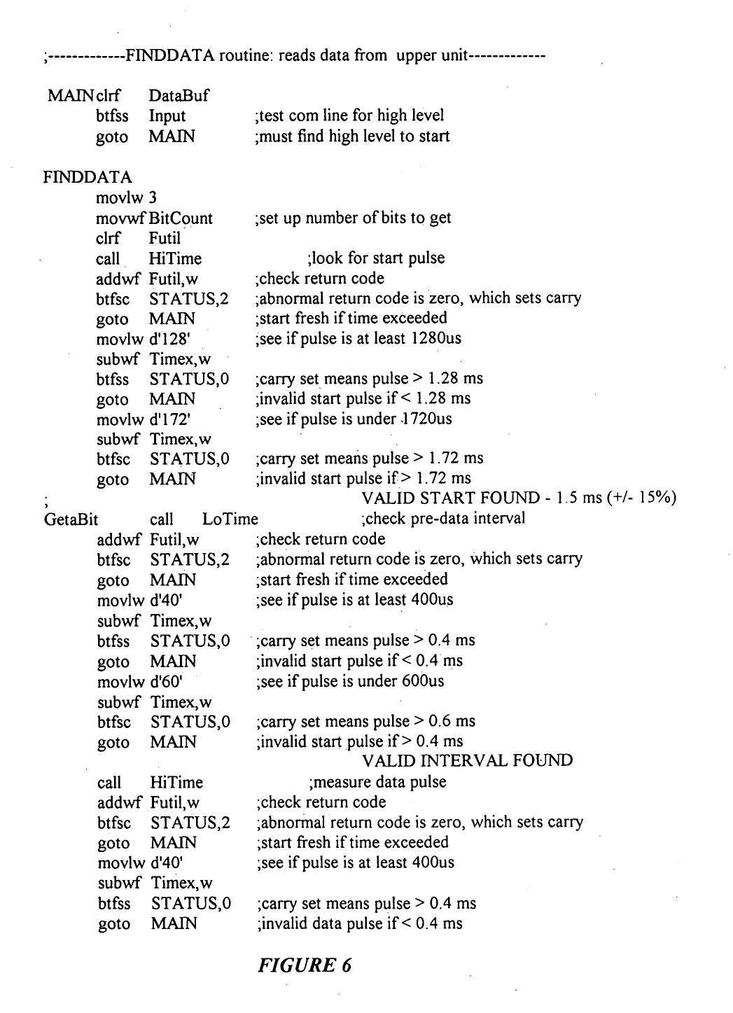

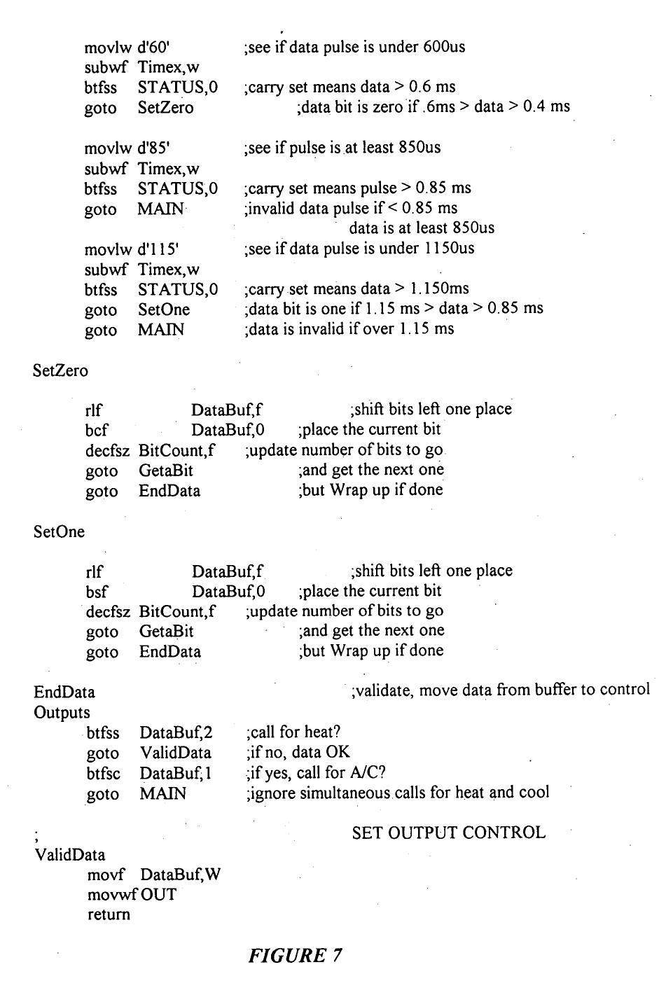

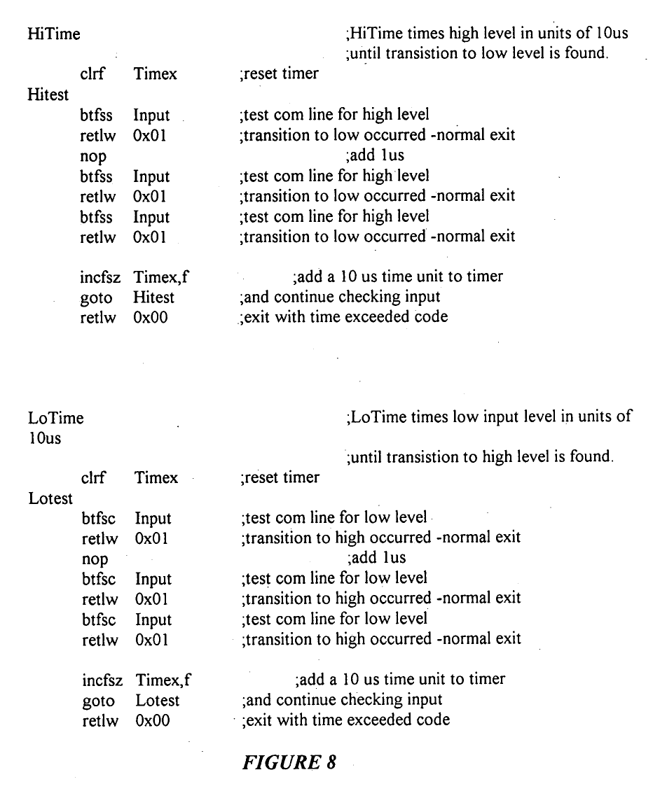

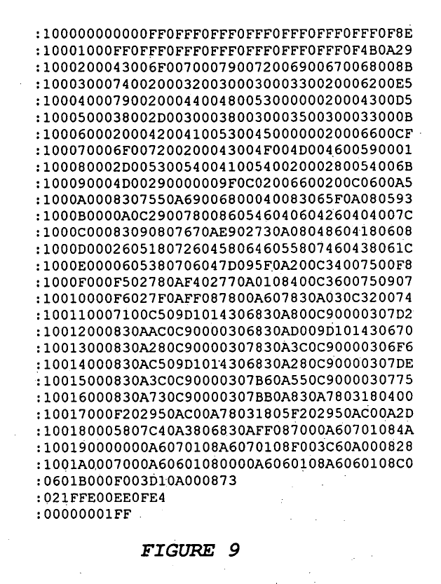

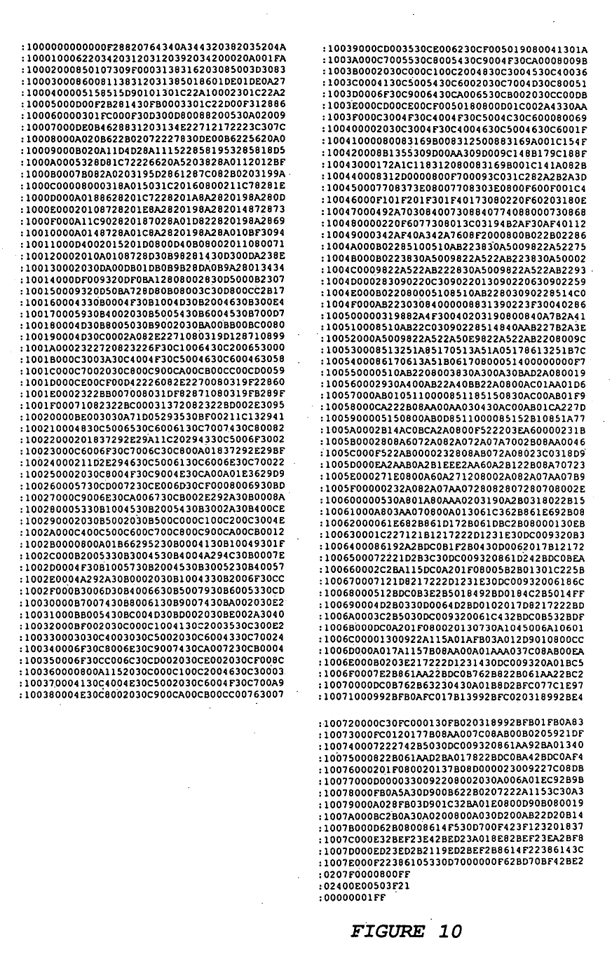

Referring to FIG. 1, a temperature sensing transducer 1 is comprised of a device having a positive (or negative) temperature coefficient and employed with associated support circuitry to produce an electrical signal, which is directly (or inversely) proportional to temperature.

Set point controls 2 are used to establish a precise voltage level corresponding to the desired maintenance temperature. Such voltage level is continuously adjustable. Circuitry may be included to select from various adjustable preset levels depending on time of day, day of week, or other criteria.

A sensitive linear comparator circuit 3 using high gain operational amplifiers using 1 and 2 as inputs completes the zero differential sensor with digital output.

In an alternate embodiment, output of the temperature transducer 1 is conveyed to microprocessor 4 using an analog to digital converter and the set point controls 2 are read directly by the microprocessor and the comparison function is implemented by logic stored in the microprocessor.

Stored program algorithms executed by the microprocessor 4 examine the sensor output to determine if controlled environment temperature is exactly the same as desired or different by the smallest fraction of a degree resolvable by the comparator. If the temperature is different, additional logic is applied to determine if and when conditioning equipment should be turned on. If temperature is the same, additional logic is applied to determine if and when equipment should be turned off. If temperature is the same, but a selected time value has elapsed since the end of last equipment operation, fan control logic may be optionally executed to periodically operate the fan for an assigned duration.

The microprocessor logic also examines the option selection controls 5 to determine user preferences for initiating or canceling temporary temperature modification, fan control, and timing intervals. Option controls and set point controls may be in the form of individual switch contacts, keypad, or similar.

The microprocessor logic also drives operator feedback 6 devices to show status of operation and assist with adjusting the set point controls. Feedback may be in the form of lights, tactile responses, display screen, or a combination.

Microprocessor logic drives isolation and termination circuitry 7, which may operate heating, ventilation, and cooling equipment directly. Microprocessor algorithms control equipment operation for more consistent temperature and ventilation control for improved comfort. In an alternate embodiment, the isolation and termination circuitry 7 is minimal and is used to communicate a digital data stream over a transmission means 8 path to an equipment controller comprised of a second microprocessor 9 and equipment interface 10, where said digital signal is produced by the logic of stored program algorithms in thermostat microprocessor 4. Transmission means 8 may be a pair of wires, a coaxial cable, optical fiber, or RF link.

The equipment controller is preferably located at, near, or within the controlled equipment, and may be a part of said equipment. Stored program algorithms in equipment controller microprocessor 9 decode the digital. signal and operate the equipment interface 10 which in turn operates HVAC equipment. Some of the common termination designations for 24 Volt AC equipment control are depicted in the equipment interface block 10.

FIG. 2 is a simplified logic flow diagram showing essential elements of the warmer process. Asynchronous input 21 is provided to the logic as a result of an operator touching the warmer button 5. If warmer status is not already active, a warmer timer 22 is initialized and the effective set point 23 is increased by a determined amount. If warmer status is already active, the input 21 is interpreted as a special request for early cancellation so the set point increase is removed 26 and warmer status is cancelled.

Warmer logic is also activated at regular time intervals 24 to note the accumulated time duration to determine if the predetermined warmer operation time has elapsed 25. At the end of scheduled warmer operation time the set point increase is removed 26 and warmer status is cancelled.

FIG. 3 shows a digital signal waveform produced by an algorithm stored in the thermostat microprocessor. An initial pulse 31 in the sequence is recognized by its pulse width to be a synchronizing pulse to indicate that data may follow. Each data pulse 32, 33, and 34 is encoded and recognized by both its width and position relative to each preceding pulse to provide an encoding and decoding protocol resistant to such effects as electromagnetic interference and phase distortion.

FIG. 4 is an example of source code statements implementing the warmer process logic of FIG. 2.

FIG. 5 is an example of source code statements implementing an encoding process to produce a digital signal protocol of the type shown in FIG. 3.

FIGS. 6-8 are an example of source code statements implementing a process to decode a digital signal protocol of the type shown in FIG. 3 and generated by the logic of FIG. 5.

FIG. 9 is an example of object code that can be programmed into microprocessor 9 of FIG. 1 to implement the described process algorithms.

FIG. 10 is an example of object code that can be programmed into microprocessor 4 of FIG. 1 to implement the described process algorithms including precision temperature control, warmer process, and signal encoding. Thus it is seen that the methods of the present invention readily achieve the ends and advantages mentioned as well as those inherent therein. While a preferred embodiment of the invention has been illustrated and described for the purposes of the present disclosure, numerous changes in the arrangement and construction of parts and steps may be made by those skilled in the art, which changes are encompassed within the scope and spirit of the present invention as defined by the appended claim.

I claim:

1. A process for accurate and consistent control of temperature and ventilation within precise performance parameters for heating, ventilation, and/or cooling systems comprising:
a) Operation of HVAC equipment essentially independent of temperature differentials;
b) Operation of HVAC equipment for minimum periods of time regardless of other operating conditions;
c) Control of equipment to assure idle periods for minimum times;
d) More efficient and comfortable ventilation options when heating or cooling apparatus is not in operation;
e) Means changing the effective temperature setting on demand on a temporary basis, and returning to the original setting automatically, with provision for canceling such operation prematurely;
f) Means encoding HVAC equipment operating parameters to produce a digital signal to communicate such parameters to said equipment or a controller operating said equipment.

2. The process of claim 1 wherein the warmer process logic is described by the flow diagram of FIG. 2.

3. The process of claim 1 wherein the warmer process is described by the source code statements of FIG. 4.

4. The process of claim 1 wherein the encoding process results in a signal similar to FIG. 3.

5. The process of claim 1 wherein the encoding process is described by the source code statements of FIG. 5.

6. The process of claim 1 wherein the decoding process is described by the source code statements of FIGS. 6-8.

7. The process of claim 1 wherein the elements are implemented by the object code statements of FIG. 9 and FIG. 10.

8. A process for encoding and decoding digital data for communication in a serial sequence comprising:
a) A synchronizing pulse distinguished from data pulses by a unique width;
b) data pulses which are distinguished by their relation to a preceding pulse;
c) data pulses in which the state of the data is determined by the width of the individual pulse.

9. The process of claim 8 in which encoding is accomplished by the statements in FIG. 5.

10. The process of claim 8 in which decoding is accomplished by the statements in FIG. 6.
